(19) United States
(12) Patent Application Publication
(10) Pub. No.: US 2006/0093793 A1
(43) Pub. Date: May 4, 2006

(54) Optical element

(75) Inventors: Akiko Miyakawa, Sagamihara-shi (JP); Toru Nakamura, Kawasaki-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Nikon Corporation, Tokyo (JP)

(21) Appl. No.: 11/303,541

(22) Filed: Dec. 17, 2005

Related U.S. Application Data
(63) Continuation-in-part of application No. PCT/JP04/08822, filed on Jun. 17, 2004.

(30) Foreign Application Priority Data
Jun. 19, 2003 (JP) 2003-174382

(51) Int. Cl. B32B 3/00

(52) U.S. Cl. 428/172

(57) ABSTRACT

The complete vertical inversion of a combination of the resin layer 2 and resin layer 3 in (a) is (b). Accordingly, (a) and (b) have the same optical characteristics. Between the resin layer 2 and resin layer 3, the resin layer that is sandwiched between the substrate 1 and the uppermost resin layer (i.e., the resin layer 2 in (a) and the resin layer 3 in (b)) does not have its surface directly contacting the outside air, but the uppermost resin layer (i.e., the resin layer 3 in (a) and the resin layer 2 in (b)) has its surface contacting the outside air. Accordingly, after comparing the resin in the resin layer 2 and the resin in the resin layer 3 in terms of environmental durability, if the environmental durability of the resin in the resin layer 2 is superior to the environmental durability of the resin in the resin layer 3, the construction shown in (b) may be adopted, and if the environmental durability of the resin in the resin layer 3 is superior to the environmental durability of the resin in the resin layer 2, then the construction shown in (a) may be adopted.

This is a continuation from PCT International Application No. PCT/JP2004/008822 filed on Jun. 17, 2004, which is hereby incorporated by reference.

### TECHNICAL FIELD

The present invention relates to an optical element such as a diffractive lens that is provided with specified optical characteristics by laminating two or more layers of resins on a matrix material.

### BACKGROUND ART

Optical elements have been publicly known in which a resin layer having a different refractive index from a matrix material such as a glass is formed on the surface of this matrix material, and the interface between this matrix material and the resin layer is formed into a particular shape, thus as a whole providing the characteristics of an optical element such as a diffractive lens. However, in such an optical element, the surface of a matrix material such as a glass must be worked, so that there is encountered the problem that this process of working the glass requires effort.

As an optical element that solves such a problem, an optical element is available in which a first resin layer having a specified surface shape pattern is formed on the surface of a matrix material such as a glass, a second resin layer having a different refractive index from the resin in the first layer is formed on top of this first resin layer, and specified optical characteristics are obtained by utilizing interference and refraction of light between these resins. This example is shown in FIG. 6. FIG. 6 is a sectional view; hatching is omitted since hatching would make the figure rather difficult to understand.

In FIG. 6, a first resin layer 12 is formed on a transparent substrate 11 consisting of a glass or the like that constitutes the matrix material via a silane coupling treatment layer. Furthermore, a pattern is formed on the surface of the resin layer 12 so that optical characteristics of a diffractive lens or the like are provided. A silane coupling treatment layer is further formed on the resin layer 12, and a second resin layer 13 with a different refractive index from the first resin layer 12 is formed on this silane coupling treatment layer. Moreover, specified optical characteristics are provided by the difference in the refractive index between the first resin layer 12 and the second resin layer 13 and the shape of the pattern formed between the two layers. Furthermore, the formation of the silane coupling treatment layers is not necessarily an essential requirement.

FIG. 6 is an element consisting of the transparent substrate 11 constituting the matrix material and the two resin layers 12 and 13; however, it would also be possible to provide a single or a plurality of resin layers having different refractive indices between the layers on top of the resin layer 13 as needed. Such an example of an optical element is described, for example, in Japanese Patent Application Kokai No. H9-127321.

In the case of optical elements that are formed by superimposing a plurality of resin layers on a matrix material in this manner, such optical elements have been designed with the same concept as in the formation of a single resin layer on a matrix material. Since the refractive index is greater with glass which is a commonly used matrix material than with resin, in cases where the design is performed with the same concept, the design is such that between the two layers of resins, one with a higher refractive index is provided on the side of the matrix material, and one with a smaller refractive index is exposed to the outside air, so that this has not been a design that takes environmental durability into account. Accordingly, there are cases in which the resin layer that is formed as the uppermost layer (i.e., the surface on the side opposite from the matrix material) and that is exposed to the outside air is scratched, or in which the adhesion of an antireflection film is poor.

In addition, when a diffractive optical surface is resin-molded with a mold, in order to improve the peeling characteristics of the mold and molded resin, gradients called “drafts” may be formed in the step structure portions of the diffractive optical surface. The invention described above also has a problem in that flare is generated in the draft portions in such a case as well.

### DISCLOSURE OF THE INVENTION

The present invention was devised in light of such circumstances, and the first object of the present invention is to provide an optical element which is formed by superimposing a plurality of resin layers on a matrix material and which has good environmental durability. Furthermore, the second object is to provide a diffractive optical element which tends not to generate flare in the diffractive optical surface that is provided with drafts.

The first invention that is used to achieve the first object described above is an optical element that is designed to have desired optical characteristics by forming a first resin layer on a matrix material, forming a second resin layer having a different refractive index from the first resin layer on this first resin layer, further forming resin layers each having a different refractive index from the resin layer formed underneath in a successive manner on this second resin layer as needed, and providing a specified shape at the interfaces between the resin layers, wherein the resin constituting the resin layer formed on the uppermost surface is most superior in terms of environmental durability among the resins forming the resin layers.

Since resin is easy to work with compared to a matrix material such as a glass, in cases where (for example) two layers of resins are superimposed, and specified characteristics are provided by the shape at the interface, it is easy to provide the same characteristics by inverting the shape at the interface, regardless of which resin layer is made the upper layer (on the opposite side from the matrix material).

The present invention utilizes this fact, and is devised so that the resin constituting the resin layer that is formed on the uppermost surface (on the opposite side from the matrix material) is most superior in terms of environmental durability among the resins forming the resin layers. By doing so, it is possible to make this optical element superior in terms of environmental durability since the surface of the resin layer that directly contacts the outside air is the surface of the resin that is most superior in terms of environmental durability.

The second invention that is used to achieve the first object described above is the first invention, wherein the property contributing to environmental durability is the hardness of the resins.

By using hardness (especially pencil hardness) as an indicator of environmental durability, and by employing a resin whose hardness is high as the resin constituting the resin layer that is formed on the uppermost surface, it is possible to obtain an optical element in which the surface of the resin is less susceptible to scratches.

The third invention that is used to achieve the first object described above is the first invention, wherein the property contributing to environmental durability is the rate of dimensional change caused by water absorption.

By using rate of dimensional change caused by water absorption as an indicator of environmental durability, and by employing a resin in which this rate of dimensional change is small as the resin constituting the resin layer that is formed on the uppermost surface, it is possible to obtain an optical element which has favorable moisture resistance.

The fourth invention that is used to achieve the first object described above is the first invention, wherein the property contributing to environmental durability is the gel fraction.

By using the gel fraction (the weight ratio before and after the immersion into methyl ethyl ketone at 70° C. for six hours) as an indicator of environmental durability, and by employing a resin having a large gel fraction as the resin constituting the resin layer that is formed on the uppermost surface, it is possible to produce an optical element in which the surface of the resin is less susceptible to scratches and the moisture resistance is favorable.

The fifth invention that is used to achieve the first object described above is the first invention, wherein the property contributing to environmental durability is the glass transition point.

By using the glass transition point as an indicator of environmental durability, and by employing a resin having a high glass transition point as the resin constituting the resin layer that is formed on the uppermost surface, it is possible to obtain an optical element which can be used even in high temperatures and which can withstand temperature variations.

The sixth invention that is used to achieve the first object described above is the first invention, wherein the property contributing to environmental durability is the coefficient of linear expansion.

By using the coefficient of linear expansion as an indicator of environmental durability, and by employing a resin having a small coefficient of linear expansion as the resin constituting the resin layer that is formed on the uppermost surface, it is possible to produce an optical element which can withstand temperature variations.

The seventh invention that is used to achieve the first object described above is the first invention, wherein the property contributing to environmental durability is moisture resistance.

By using moisture resistance as an indicator of environmental durability, and by employing a resin having a high moisture resistance as the resin constituting the resin layer that is formed on the uppermost surface, it is possible to obtain an optical element which tends not to be affected even in conditions such as high humidity and high moisture content.

The eighth invention that is used to achieve the first object described above is an optical element that is designed to have desired optical characteristics by forming a first resin layer on a matrix material, forming a second resin layer having a different refractive index from the first resin layer on this first resin layer, further forming resin layers each having a different refractive index from the resin layer formed underneath in a successive manner on this second resin layer as needed, and providing a specified shape at the interfaces between the resin layers, wherein among the resins that form the resin layers, the resin in which variations in transmissivity in a light resistance test by means of a carbon fade meter are the greatest is not used in the first resin layer on the side from which light is caused to be incident.

By exposure to ultraviolet rays generated from a carbon fade meter, a resin changes its properties, and the transmissivity drops. In the present invention, however, this resin is not used in the first resin layer on the side from which light is caused to be incident. Accordingly, when subjected to ultraviolet light, a resin whose sensitivity to ultraviolet light is high is prevented from receiving ultraviolet light first; as a result, an optical element which can withstand ultraviolet light can be produced.

The ninth invention that is used to achieve the first object described above is an optical element that is designed to have desired optical characteristics by forming a first resin layer on a matrix material, forming a second resin layer having a different refractive index from the first resin layer on this first resin layer, further forming resin layers each having a different refractive index from the resin layer formed underneath in a successive manner on this second resin layer as needed, and providing a specified shape at the interfaces between the resin layers, wherein if a fluorine-containing resin is used in a resin layer, this resin layer is not used as the uppermost resin layer.

In the present invention, since the surface of the fluorine-containing resin layer never contacts the outside air directly, the surface of the optical element tends not to get scratches, and a deterioration of the adhesion of an antireflection film can be prevented. Furthermore, a fluorine-containing resin may also be a resin consisting of a mixture of a plurality of resins or a polymer.

The tenth invention that is used to achieve the first object described above is the ninth invention, wherein the interface between the fluorine-containing resin and the resin formed on top of this fluorine-containing resin is formed as a diffractive optical surface.

In cases where a diffractive optical surface consisting of a relief pattern, a step shape, or the like is formed between a fluorine-containing resin and another resin, the two resins are joined by forming the surface shape of the resin that is formed on the lower side as a diffractive optical surface using a mold, and pouring the other resin on the surface of this solidified resin. The term “diffractive optical surface” refers to a surface on which a diffractive effect is generated; a diffractive optical surface is generally not constructed from a smooth portion (continuous surface) such as the surface of a spherical lens or aspherical lens, and has some kind of a noncontinuous surface (surface whose shape is expressed by a noncontinuous function).

In this case, according to the findings of the inventor, a fluorine-containing resin has good peeling characteristics from a mold (especially a metal mold), and even if a mold having a diffractive optical surface consisting of a complex surface shape such as a relief pattern and a step shape is used, this shape can be accurately transferred.

The eleventh invention that is used to achieve the second object described above is a diffractive optical element which is an optical element that is designed to have desired optical characteristics by forming a first resin layer on a matrix material that has a positive optical power, forming a second resin layer having a different refractive index from the first resin layer on this first resin layer, further forming resin layers each having a different refractive index from the resin layer formed underneath in a successive manner on this second resin layer as needed, and providing a specified shape at the interfaces between the resin layers, wherein the refractive index of the first resin layer is smaller than that of the second resin layer, and the interface between the first resin layer and the second resin layer has a relief pattern shape, with this relief pattern shape consisting of repetitions of a pattern which is such that the thickness of the first resin layer gradually increases moving from the center of the first resin layer toward the edges, and the thickness of the first resin layer has a subsequent sharp-gradient decrease.

In the present invention, the matrix material has a positive optical power, and a positive optical power is further generated by the relief pattern between the first resin layer and second resin layer.

As will be described later in the Best Mode for Carrying Out the Invention section, in the present means, after a first resin layer is formed between the matrix material and mold, in the portions of the relief pattern where the thickness of the first resin layer decreases, the thickness is not decreased at an abrupt vertical angle, but has a sharp-gradient decrease in order to facilitate the peeling characteristics of the first resin and mold. In this case, light rays incident on the relief pattern surface are oriented toward the center of the first resin layer due to the positive optical power of the matrix material; since the direction of the sharp gradients is the same as the direction of these light rays, it is possible to reduce the light rays crossing the portion of the interface having the sharp gradients. Accordingly, the generation of flare can be reduced.

The twelfth invention that is used to achieve the second object described above is a diffractive optical element which is an optical element that is designed to have desired optical characteristics by forming a first resin layer on a matrix material that has a negative optical power, forming a second resin layer having a different refractive index from the first resin layer on this first resin layer, further forming resin layers each having a different refractive index from the resin layer formed underneath in a successive manner on this second resin layer as needed, and providing a specified shape at the interfaces between the resin layers, wherein the refractive index of the first resin layer is smaller than that of the second resin layer, and the interface between the first resin layer and the second resin layer has a relief pattern shape, with this relief pattern shape consisting of repetitions of a pattern which is such that the thickness of the first resin layer gradually decreases moving from the center of the first resin layer toward the edges, and the thickness of the first resin layer has a subsequent sharp-gradient increase.

In this invention as well, the generation of flare can be reduced for the same reason as in the eleventh invention.

### BRIEF DESCRIPTION OF THE DRAWINGS

FIG. 1 is a diagram used to illustrate a working configuration of the present invention.

FIG. 2 is a diagram used to illustrate another working configuration of the present invention.

FIG. 3 is a model diagram of the diffractive optical surface shown in FIG. 2 as seen in enlargement.

FIG. 4 is a diagram showing the structure in cases where a concave power is also given to a transparent substrate when a concave power is given to a diffractive optical element.

FIG. 5 is a model diagram of the diffractive optical surface shown in FIG. 4 as seen in enlargement.

FIG. 6 is a diagram showing a conventional example of an optical element consisting of two layers of resins.

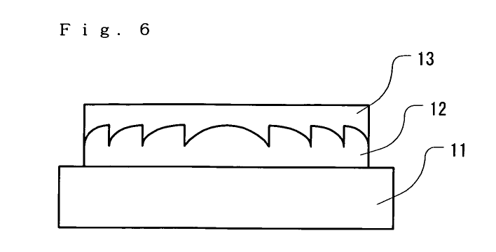

### BEST MODE FOR CARRYING OUT THE INVENTION

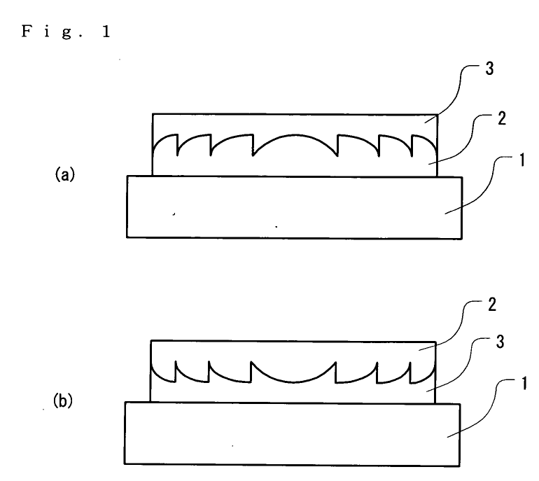

Examples of optical elements constituting working configurations of the present invention will be described below using the figures. FIG. 1 is a diagram used to illustrate a working configuration of the present invention; FIG. 1 is a sectional view, but hatching is omitted. Furthermore, these optical elements have a circular shape when seen in a plan view. The same is true for the following figures. In FIG. 1(a), a first resin layer 2 is formed via a silane coupling treatment layer on a transparent substrate 1 consisting of a glass or the like that constitutes the matrix material. Then, a pattern is formed on the surface of the resin layer 2 so that optical characteristics of a diffractive lens or the like are provided. A silane coupling treatment layer is further formed on the first resin layer 2, and a second resin layer 3 having a different refractive index from the first resin layer 2 is formed on top of this silane coupling treatment layer. Moreover, this optical element is designed to have specified optical characteristics by the difference in the refractive index between the first resin layer 2 and the second resin layer 3 and the shape of the pattern formed between the two resin layers.

An optical element that provides the same optical characteristics as those of the optical element shown in FIG. 1(a) can also be realized with the construction shown in FIG. 1(b). In FIG. 1(b), a first resin layer 3 is formed via a silane coupling treatment layer on a transparent substrate 1 consisting of a glass or the like that constitutes the matrix material. Then, a pattern is formed on the surface of the resin layer 3 so that optical characteristics of a diffractive lens or the like are provided. A silane coupling treatment layer is further formed on the resin layer 3, and a second resin layer 2 having a different refractive index from the first resin layer 3 is formed on top of this silane coupling treatment layer. Moreover, this optical element is designed to have specified optical characteristics by the difference in the refractive index between the first resin layer 3 and the second resin layer 2 and the shape of the pattern formed between the two resin layers. Furthermore, the formation of silane coupling treatment layers is not necessarily an essential requirement.

The shape of the interface between the resin layer 2 and resin layer 3 is vertically inverted between the case of FIG. 1(a) and the case of FIG. 1(b). Specifically, the complete vertical inversion of a combination of the resin layer 2 and resin layer 3 in (a) is (b). Accordingly, it would not be necessary to explain the fact that (a) and (b) have the same optical characteristics.

Between the resin layer 2 and resin layer 3, the resin layer that is sandwiched between the substrate 1 and the uppermost resin layer (i.e., the resin layer 2 in (a) and the resin layer 3 in (b)) does not have its surface directly contacting the outside air, but the uppermost resin layer (i.e., the resin layer 3 in (a) and the resin layer 2 in (b)) has its surface contacting the outside air.

Accordingly, after comparing the resin in the resin layer 2 and the resin in the resin layer 3 in terms of environmental durability, if the environmental durability of the resin in the resin layer 2 is superior to the environmental durability of the resin in the resin layer 3, the construction shown in (b) may be adopted, and if the environmental durability of the resin in the resin layer 3 is superior to the environmental durability of the resin in the resin layer 2, then the construction shown in (a) may be adopted.

Indicators of environmental durability include, for example, the hardness of the resins, the rate of dimensional change caused by water absorption, the gel fraction, the glass transition point, and the coefficient of linear expansion.

Furthermore, after comparing the strength (degree of resistance to alteration) against ultraviolet light of the resin in the resin layer 2 relative to the resin in the resin layer 3, if the resin in the resin layer 2 is superior to the resin in the resin layer 3, it would be possible to position the resin layer 2 in the direction of incidence of light, and if the resin in the resin layer 3 is superior to the resin in the resin layer 2, then it would also be possible to position the resin layer 3 in the direction of incidence of light.

Moreover, by adopting the construction shown in (a) if the resin in the resin layer 2 is a fluorine-containing resin, and by adopting the construction shown in (b) if the resin in the resin layer 3 is a fluorine-containing resin, it is possible to make the optical element less susceptible to scratches, as well as to prevent the adhesion of an antireflection film from deteriorating.

In addition, an example of a method for manufacturing an optical element of the type shown in FIG. 1 will be described below.

Silane coupling treatment is performed on the surface of the transparent substrate 1, a metal mold having a specified shape and the transparent substrate 1 are caused to face each other, and the space between the transparent substrate 1 and metal mold is filled with an ultraviolet curing type resin that forms the resin layer 2 (in the case of FIG. 1(a)) or the resin layer 3 (in the case of FIG. 1(b)) using a dispenser or the like. Furthermore, irradiation with ultraviolet light is performed from the side of the transparent substrate 1, so that the resin is cured to form a resin layer, and the metal mold is peeled off. Moreover, silane coupling treatment is performed on the surface of this formed resin layer, this surface is caused to face a transparent mold whose surface is flat, and the space between the resin layer and transparent mold is filled with an ultraviolet curing type resin that forms the resin layer 3 (in the case of FIG. 1(a)) or the resin layer 2 (in the case of FIG. 1(b)) on the surface. In addition, ultraviolet light is irradiated from the side of the transparent mold, so that the filled resin is cured to form a resin layer, and the transparent mold is peeled off.

In cases where a complex diffractive optical surface is formed between the resin layer 2 and resin layer 3 as shown in FIG. 1, it is desirable that a fluorine-containing resin be used as the resin layer 2 (in the case of FIG. 1(a)) or the resin layer 3 (in the case of FIG. 1(b)) so that the peeling characteristics from the metal mold on which the diffractive optical surface is formed are improved.

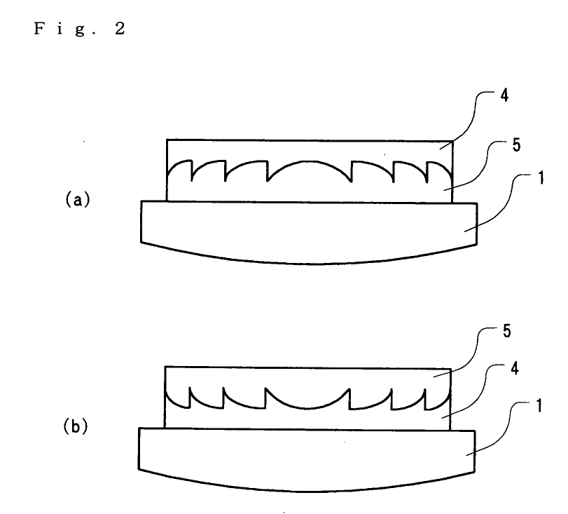

FIG. 2 is a diagram used to illustrate another working configuration of the present invention. In a diffractive optical element, there are cases in which an optical power is also given to the transparent substrate 1 in addition to the diffractive action at the diffractive optical surface. FIG. 2 is a diagram showing a case in which a positive optical power is given to the transparent substrate 1. In this case, it is common that a positive optical power is also given to the diffractive optical surface formed at the interface between the two resin layers so that this optical power will work in conjunction with the optical power of the transparent substrate 1.

In the example shown in FIG. 2, 4 is a low-refractive index resin layer, and 5 is a high-refractive index resin layer. The optical elements shown in FIG. 2 are manufactured by the same method used for the optical elements shown in FIG. 1.

Here, in cases where the high-refractive index resin layer 5 is formed on the transparent substrate 1, and the low-refractive index resin layer 4 is formed on top of this high-refractive index resin layer 5, the diffractive optical surface between these resin layers is as shown in FIG. 2(a). Specifically, the thickness of the high-refractive index resin layer 5 gradually decreases moving from the center toward the edges, increases in an abrupt vertical manner upon reaching certain positions, and again gradually decreases from these positions, and such a structure is repeated.

On the other hand, in cases where the low-refractive index resin layer 4 is formed on the transparent substrate 1, and the high-refractive index resin layer 5 is formed on top of this low-refractive index resin layer 4, the diffractive optical surface between these resin layers is as shown in FIG. 2(b). Specifically, the thickness of the low-refractive index resin layer 4 gradually increases moving from the center toward the edges, decreases in an abrupt vertical manner upon reaching certain positions, and again gradually increases from these positions, and such a structure is repeated.

However, if steps are provided in this manner, there are cases in which the mold cannot be peeled off easily when the mold is to be peeled off from the resin layer that is formed between the transparent substrate 1 and the mold in the manufacturing process. Accordingly, a vertical step structure is not used, and portions corresponding to the vertical step structure are often formed as portions having sharp gradients. Such gradients are referred to as drafts.

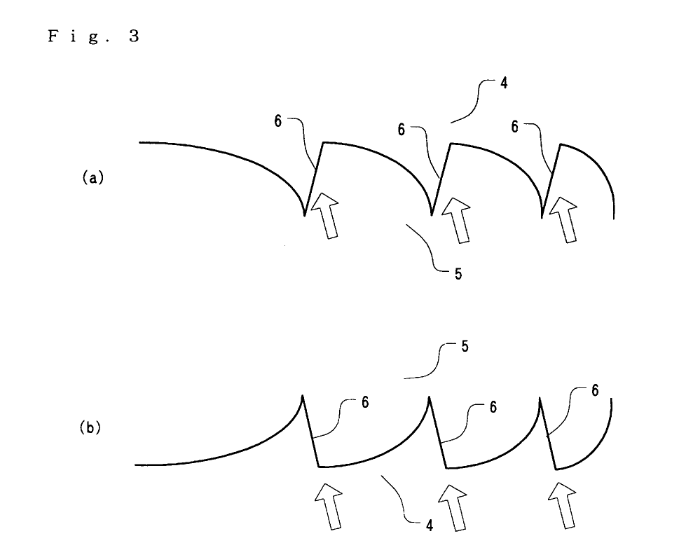

FIG. 3 is a model diagram of the diffractive optical surface shown in FIG. 2 as seen in enlargement. FIG. 3(a) is an enlarged view of the diffractive optical surface (relief pattern surface) between the high-refractive index resin layer 5 and low-refractive index resin layer 4 in FIG. 2(a), and FIG. 3(b) is an enlarged view of the diffractive optical surface (relief pattern surface) between the high-refractive index resin layer 5 and low-refractive index resin layer 4 in FIG. 2(b). In these figures, 6 indicates draft surfaces.

In FIG. 3, light rays incident from the side of the transparent substrate 1 are incident on the diffractive optical surface while being oriented from the edge portion toward the central portion as indicated by the arrows by means of the convex power of the transparent substrate 1 in FIG. 2. Accordingly, in the case of (a), these light rays pass through the draft surfaces 6. In the case of (b), in contrast, the light rays are close to being parallel to the draft surfaces 6, so that the light rays passing through the draft surfaces 6 are extremely reduced. Accordingly, in the case of (b), it is less likely to generate flare than in the case of (a).

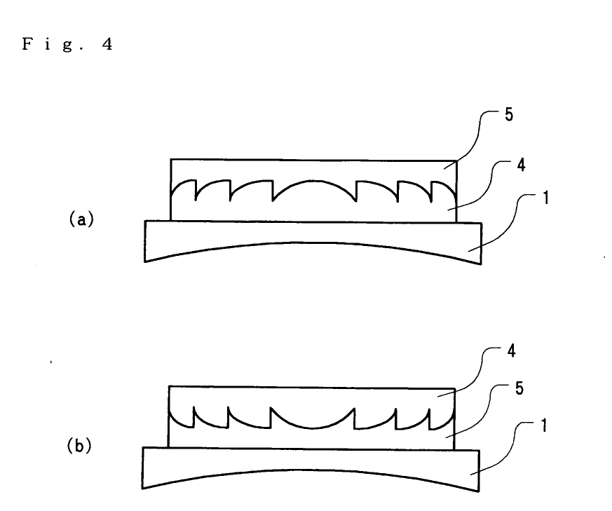

FIG. 4 is a diagram showing the structure in cases where a concave power is also given to a transparent substrate when a concave power is given to a diffractive optical element. In cases where the diffractive optical surface is provided with a concave power, the high-refractive index resin layer 5 and low-refractive index resin layer 4 in FIG. 2 can be reversed. Accordingly, if the high-refractive index resin layer 5 and low-refractive index resin layer 4 are disposed as shown in FIGS. 4(a) or 4(b), and the interface between these resin layers is formed as in FIGS. 4(a) or 4(b), then a concave power can be given to the diffractive optical surface.

In this case as well, in the manufacturing process of these optical elements (the same as the manufacturing process of the optical elements shown in FIG. 1), a resin layer (i.e., the low-refractive index resin layer 4 in the case of FIG. 4(a) and the high-refractive index resin layer 5 in the case of FIG. 4(b)) is first formed between the transparent substrate 1 and mold, and drafts are provided in order to improve the peeling characteristics when the mold is peeled off.

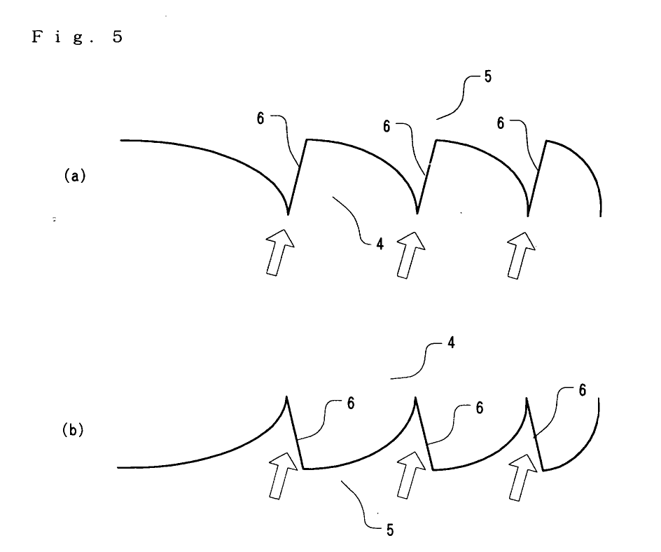

FIG. 5 is a model diagram of the diffractive optical surface shown in FIG. 4 as seen in enlargement. FIG. 5(a) is an enlarged view of the diffractive optical surface (relief pattern surface) between the high-refractive index resin layer 5 and low-refractive index resin layer 4 in FIG. 4(a), and FIG. 5(b) is an enlarged view of the diffractive optical surface (relief pattern surface) between the high-refractive index resin layer 5 and low-refractive index resin layer 4 in FIG. 4(b). In these figures, 6 indicates draft surfaces.

In FIG. 5, light rays incident from the side of the transparent substrate 1 are incident on the diffractive optical surface while being oriented from the central portion toward the edge portion as indicated by the arrows by means of the concave power of the transparent substrate 1 in FIG. 4. Accordingly, in the case of (b), these light rays pass through the draft surfaces 6. In the case of (a), on the other hand, the light rays are close to being parallel to the draft surfaces 6, so that the light rays passing through the draft surfaces 6 are extremely reduced. Accordingly, in the case of (a), it is less likely to generate flare than in the case of (b).

### Embodiment 1

Optical elements having the shapes shown in FIG. 1 (diffractive lenses having the function of a convex lens) were formed. The external diameter of the optical elements (resin portion) was 60 mm, the diffraction grating was a circular shape, the pitch in the vicinity of the center of the lens was 2 mm, with this pitch becoming narrower toward the outer circumference as shown in FIG. 1, so that the pitch in the vicinity of the outer circumference was 0.12 mm.

A resin whose main component is urethane acrylate was used as the resin 2, and a resin containing fluorinated acrylate was used as the resin 3. The refractive index of the resin 2 is greater than the refractive index of the resin 3. The characteristics of the cured materials of the resin 2 and resin 3 are as shown in Table 1. In Table 1, variations in transmissivity before and after light resistance test by means of a carbon fade meter (abbreviated and described as “variations in transmissivity before and after carbon fade”) indicate the results of exposure to ultraviolet light emitted from a carbon fade meter device for 500 hours. Furthermore, glass (BK7) was used as the substrate 1.

TABLE 1

| | | | | | | Coefficient of linear |
|---|---|---|---|---|---|---|
| | | | | | | expansion (room |
| | | Variations in transmissivity | Coefficient of | Gel | Glass transition | temperature |
| | Pencil hardness | before and after carbon fade | water absorption | fraction | point | to 150° C.) |
| Resin 2 | H | −2% | 0.4% | 98% | 110° C. | 1 × 10⁻⁴ |
| Resin 3 | 2B | −5% | 0.8% | 92% | 70° C. | 2 × 10⁻⁴ |

With respect to the molded optical elements, the following tests were performed: the presence or absence of coating cracking in a case where antireflection coating was applied, the presence or absence of scratching on the surface in a case where the optical elements were wiped 10 times by hand using a wipe cloth containing ethanol (commercial name: Savina Minimax (wiping cloth), manufactured by Kanebo Gohsen, Ltd.), a moisture resistance test in which the optical elements were exposed to an atmospheric temperature of 60° C. and a humidity of 80% for 200 hours, and a temperature cycle test in which a temperature cycle of −40° C. to 70° C. was performed five times. Table 2 shows the results of comparison between the optical element using the system (a) shown in FIG. 1 (i.e., the optical element in which the surface of the resin 3 is exposed to the outside air) and the optical element using the system (b) (i.e., the optical element in which the surface of the resin 2 is exposed to the outside air).

TABLE 2

| | | Abrasion | Moisture | Temperature |
|---|---|---|---|---|
| | Antireflection coating | resistance | resistance test | cycle |
| (a) | Coating cracking present | Scratching | Discoloration | Stripping |
| | | present | (clouding) | generated |
| (b) | Coating cracking absent | Scratching | No | No stripping |
| | | absent | discoloration | |

As is clear from the results in Table 2, environmental durability is higher in the construction of FIG. 1(b) in which the resin 2 that has higher environmental durability is exposed to the outside air. Furthermore, it is thought that the influential factors on the presence or absence of coating cracking in the antireflection coating are the glass transition points and coefficient of linear expansion, the influential factors on the abrasion resistance are the pencil hardness and gel fraction, the influential factors on the moisture resistance test are the coefficient of water absorption and gel fraction, and the influential factors on the stripping of the resin in the temperature cycle are the glass transition point and coefficient of linear expansion.

### Embodiment 2

Diffractive lenses having a positive power were manufactured. The shape of the diffraction grating was a shape shown in FIG. 2(b), the external diameter of the optical elements was 60 mm, the height of the grating was 20 μm, and the grating pitch was 2 mm in the vicinity of the center and 0.12 mm in the vicinity of the outer circumference, so that the pitch was designed to be narrower toward the outer circumferential surface.

A resin whose main component is urethane acrylate was used as the high-refractive index resin 5, and a resin containing fluorinated acrylate was used as the low-refractive index resin 4.

In the first diffractive lens, no drafts were formed in the relief pattern, so that this lens had a vertical step structure. In the second diffractive lens, drafts were formed in the relief pattern as shown in FIG. 3, and these drafts were formed so that the inclination increased toward the edge portions of the diffractive lens, and the gradient at the outermost circumference was 7°.

With regard to these two diffractive lenses, after molding the low-refractive index resin 4 by means of a mold, the peeling force when the mold is peeled off was measured. As a result, the peeling force for the first diffractive lens was 100 kgf, but the peeling force for the second diffractive lens was decreased to a half (i.e., 50 kgf), so that the mold could be easily peeled off. Furthermore, when the molded grating was observed under a microscope, it was seen that the grating was missing in the first diffractive lens, while in the second diffractive lens, such absence of the grating was not seen at all.

The percentage of the primary diffracted light at three wavelengths in the diffractive lenses formed in this manner was measured using laser light. The results are shown in Table 3. As the percentage of the primary diffracted light is greater, the performance is relatively superior. As is seen from Table 3, the performance of the second diffractive lens is superior to that of the first diffractive lens in terms of optical characteristics as well.

TABLE 3

| | Wavelength | | |
|---|---|---|---|
| | 460 nm | 540 nm | 633 nm |
| First diffractive lens | 95% | 94% | 91% |
| Second diffractive lens | 98% | 98% | 96% |

1. An optical element comprising:
a matrix material;
a plurality of resin layers formed in succession on the matrix material, each of the resin layers having a different refractive index than a resin layer immediately below;
wherein a predetermined shape is formed at each interface between resin layers; and
wherein one of the resin layers contains fluorine and is not provided at an uppermost position in the plurality of successive resin layers.

2. The optical element according to claim 1, wherein the interface between the fluorine-containing resin layer and a resin layer formed on the fluorine-containing resin layer is formed to be a diffractive optical surface.

3. A diffractive optical element comprising:
a matrix material having a positive optical power;
a plurality of resin layers formed in succession on the matrix material, each of the resin layers having a different refractive index than a resin layer immediately below;
wherein a predetermined shape is formed at each interface between resin layers;
wherein a first one of the resin layers, which is formed on the matrix material, has a smaller refractive index than a second one of the resin layers, which is formed on the first, resin layer;
wherein the interface between the first and second resin layers has a relief pattern shape comprising repetitions of a pattern such that a thickness of the first resin layer gradually increases outward from a center thereof, and the thickness of the first resin layer has a sharp-gradient decrease at an outer position with respect to the repeated pattern.

4. A diffractive optical element comprising:
a matrix material having a negative optical power;
a plurality of resin layers formed in succession on the matrix material, each of the resin layers having a different refractive index than a resin layer immediately below;
wherein a predetermined shape is formed at each interface between resin layers;
wherein a first one of the resin layers, which is formed on the matrix material, has a smaller refractive index than a second one of the resin layers, which is formed on the first resin layer;
wherein the interface between the first and second resin layers has a relief pattern shape comprising repetitions of a pattern such that a thickness of the first resin layer gradually decreases outward from a center thereof, and the thickness or the first resin layer has a sharp-gradient increase at an outer position with respect to the repeated pattern.
